(19) United States
(12) Patent Application Publication
(10) Pub. No.: US 2023/0178807 A1
(43) Pub. Date: Jun. 8, 2023

(54) ELECTROLYTE, AND ELECTROCHEMICAL APPARATUS AND ELECTRONIC APPARATUS INCLUDING ELECTROLYTE

(71) Applicant: Ningde Amperex Technology Limited, Ningde City (CN)

(72) Inventors: Jianyu Liu, Ningde City (CN); Mingming Guan, Ningde City (CN); Jianming Zheng, Ningde City (CN); Jian Liu, Ningde City (CN)

(73) Assignee: Ningde Amperex Technology Limited, Ningde City (CN)

(21) Appl. No.: 18/103,170

(22) Filed: Jan. 30, 2023

Related U.S. Application Data
(63) Continuation of application No. PCT/CN2020/108961, filed on Aug. 13, 2020.

(51) Int. Cl. H01M 10/0567; H01M 10/0525; H01M 10/0569; H01M 4/62

(52) U.S. Cl. CPC H01M 10/0567; H01M 10/0525; H01M 10/0569; H01M 4/628; H01M 2300/0025; H01M 2004/028

(57) ABSTRACT

An electrolyte, including a compound of formula I and lithium difluorophosphate, where X is selected from a substituted or unsubstituted C₁₋₁₀ alkyl group, a substituted or unsubstituted C₂₋₁₀ alkenyl group, a substituted or unsubstituted C₁₋₅ alkyl sulfonyl group, and a substituted or unsubstituted C₂₋₅ acyl group. In the case of substitution, a substituent is selected from a cyano group and halogen. This application further relates to an electrochemical apparatus and an electronic apparatus that include the electrolyte.

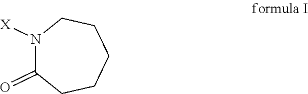

### CROSS REFERENCE TO RELATED APPLICATIONS

This present application is a continuation application of PCT application PCT/CN2020/108961, filed on Aug. 13, 2020, the disclosure of which is hereby incorporated by reference in its entirety.

### TECHNICAL FIELD

This application relates to the field of energy storage technologies, and in particular, to an electrolyte, and an electrochemical apparatus and an electronic apparatus that include the electrolyte.

### BACKGROUND

With the popularization and application of smart products, demands on electronic products such as mobile phones, notebooks, and cameras have been increasing year on year. As an operating power source for electronic products, lithium-ion batteries are characterized by high energy density, no memory effect, high operating voltage, and the like, and are gradually taking place of traditional Ni—Cd and MH-Ni batteries. However, as electronic products are developing to be thinner, lighter, and more portable, requirements for lithium-ion batteries have been continuously increased. Therefore, developing high-safety and long-life lithium-ion batteries is one of the main demands of the market.

### SUMMARY

This application provides an electrolyte to resolve at least one problem existing in related fields. In particular, the electrolyte provided in this application can significantly improve hot-box performance and room-temperature cycling performance of electrochemical apparatuses. This application further relates to an electrochemical apparatus and an electronic apparatus that include the electrolyte.

This application provides an electrolyte, where the electrolyte includes a compound of formula I and lithium difluorophosphate,

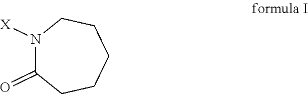

where X is selected from a substituted or unsubstituted C₁₋₁₀ alkyl group, a substituted or unsubstituted C₂₋₁₀ alkenyl group, a substituted or unsubstituted C₁₋₅ alkyl sulfonyl group, and a substituted or unsubstituted C₂₋₅ acyl group, and in the case of substitution, a substituent is selected from a cyano group and halogen.

In some embodiments, the compound of formula I is selected from at least one of N-acetylcaprolactam, N-vinylcaprolactam, N-methylcaprolactam, N-trifluoromethylcaprolactam, or N-methylsulfonylcaprolactam.

In some embodiments, based on a total weight of the electrolyte, a percentage of the compound of formula I ranges from 0.01% to 3%, and a percentage of the lithium difluorophosphate ranges from 0.01% to 1%.

In some embodiments, based on a total weight of the electrolyte, a percentage of the compound of formula I is a %, a percentage of the lithium difluorophosphate is b %, and a ratio a/b of the compound of formula I to the lithium difluorophosphate in the electrolyte ranges from 0.01 to 30.

In some embodiments, the electrolyte of this application further includes at least one of the following compounds:

(1) a first additive, where the first additive includes a compound of formula II, and based on a total weight of the electrolyte, a percentage of the first additive ranges from 0.01% to 5%:

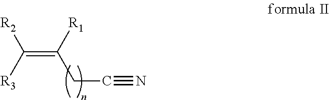

where R₁, R₂, and R₃ each are independently selected from hydrogen, halogen, a substituted or unsubstituted C₁₋₁₂ alkyl group, a substituted or unsubstituted C₃₋₈ cycloalkyl group, and a substituted or unsubstituted C₆₋₁₂ aryl group, and in the case of substitution, a substituent is selected from a cyano group, a nitro group, halogen, and a sulfonyl group, and n is an integer from 0 to 7;

(2) a second additive, where the second additive includes a compound of formula III, and based on a total weight of the electrolyte, a percentage of the second additive ranges from 0.1% to 5%:

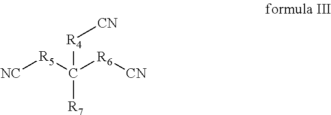

where R₄, R₅, R₆ are each independently selected from a substituted or unsubstituted C₁₋₁₂ alkylidene group, a substituted or unsubstituted C₂₋₁₂ alkenylene group, an R₀—S—R group, an R₀—O—R group, or an O—R group, and R₇ is selected from H, fluorine, a cyano group, a substituted or unsubstituted C₁₋₁₂ alkyl group, a substituted or unsubstituted C₂₋₁₂ alkenyl group, an R₀—S—R group, an R₀—O—R group, or an O—R group, where R₀ and R are each independently selected from a substituted or unsubstituted C₁₋₆ alkenylene group; and in the case of substitution, a substituent is selected from halogen, a cyano group, a C₁₋₆ alkyl group, a C₂₋₆ alkenyl group, and any combination thereof;

(3) a third additive, where the third additive includes a dinitrile compound or an ether dinitrile compound, and based on a total weight of the electrolyte, a percentage of the third additive ranges from T % to 8%; and

(4) a fourth additive, where the fourth additive includes at least one of 1,3-propanesultone, ethylene sulfate, or fluoroethylene carbonate, and based on a total weight of the electrolyte, a percentage of the fourth additive ranges from 0.10% to 10%.

In some embodiments, the compound of formula II includes at least one of acrylonitrile, butene nitrile, methacrylonitrile, 3-methyl butene nitrile, 2-pentene nitrile, 2-methyl-2 butene nitrile, or 2-methyl-2 pentene nitrile; and the compound of formula III includes at least one of the following compounds:

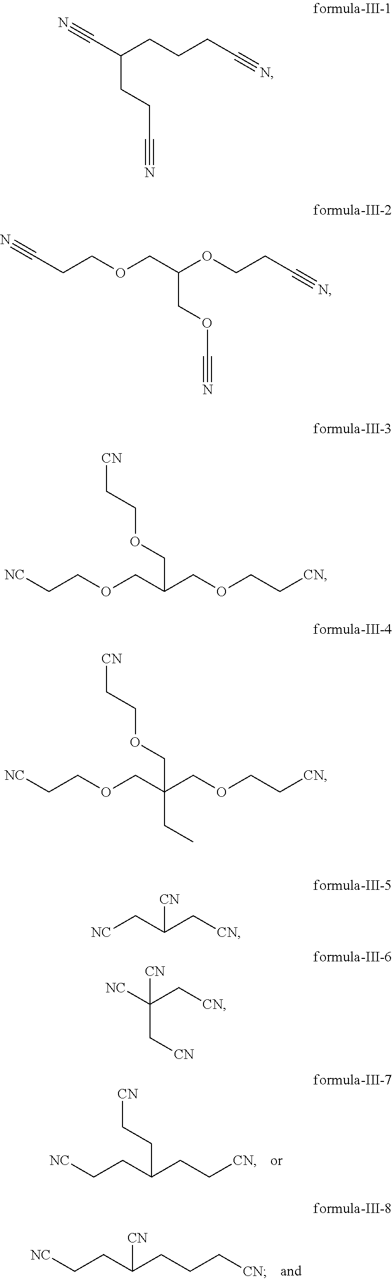

the dinitrile compound or etherdinitrile compound includes at least one of malononitrile, succinonitrile, glutaronitrile, adiponitrile, pimelonitrile, suberonitrile, azelanitrile, sebaconitrile, tetramethylsuccinonitrile, 2-methyl glutaronitrile, 2-methylene glutaronitrile, 2,4-dimethyl glutaronitrile, 2,2,4,4-tetramethyl glutaronitrile, or ethylene glycolbis(propionitrile)ether.

In some embodiments, the electrolyte further includes an organic solvent and a lithium salt, where the organic solvent includes at least one selected from ethylene carbonate, propylene carbonate, dimethyl carbonate, diethyl carbonate, ethyl methyl carbonate, ethyl acetate, methyl propionate, ethyl propionate, or propyl propionate; the lithium salt includes at least one selected from lithium hexafluorophosphate, lithium bis(trifluoromethanesulfonyl)imide, lithium bis(fluorosulfonyl)imide, lithium tetrafluoroborate, lithium bis(oxalato)borate, or lithium difluoro(oxalato)borate.

This application further provides an electrochemical apparatus, where the electrochemical apparatus includes an electrolyte according to this application.

In some embodiments, the electrochemical apparatus according to this application further includes a positive electrode, where the positive electrode includes:

a positive electrode current collector;

a positive electrode active material layer; and

an insulating layer, disposed on the positive electrode current collector and meeting at least one of condition (a), condition (b), or condition (c):

(a) a gap is reserved between the insulating layer and the positive electrode active material layer, a width of the gap being less than or equal to 2 mm;

(b) the insulating layer includes inorganic particles, where the inorganic particles include at least one of aluminum oxide, silicon dioxide, magnesium oxide, titanium oxide, hafnium oxide, tin oxide, ceria oxide, nickel oxide, zinc oxide, calcium oxide, zirconium dioxide, yttrium oxide, silicon carbide, boehmite, aluminum hydroxide, magnesium hydroxide, calcium hydroxide, or barium sulfate; and

(c) the insulating layer includes a polymer, where the polymer includes at least one of a homopolymer of polyvinylidene fluoride, a copolymer of polyvinylidene fluoride, a copolymer of hexafluoropropylene, polystyrene, polyphenylacetylene, polyvinyl sodium, polyvinyl potassium, polymethyl methacrylate, polyethylene, polypropylene, or polytetrafluoroethylene.

This application further provides an electronic apparatus, where the electronic apparatus includes an electrochemical apparatus according to this application.

Additional aspects and advantages of the embodiments of this application are partially described and presented in subsequent descriptions, or explained by implementation of the embodiments of this application.

### BRIEF DESCRIPTION OF DRAWINGS

To describe embodiments of this application, the following briefly describes the accompanying drawings required for describing the embodiments of this application or the prior art. Apparently, the accompanying drawings described below are merely some embodiments of this application. A person skilled in the art may still derive drawings for other embodiments from structures shown in these accompanying drawings.

FIG. 1A and FIG. 1B show a positive electrode according to this application, where the positive electrode includes a positive electrode current collector (1), a first-surface positive electrode active substance layer (2), a second-surface active substance layer (3), and an insulating layer (4).

FIG. 2 shows a scanning electron microscope image for a copper precipitation test on a negative electrode.

### DETAILED DESCRIPTION

Embodiments of this application are described in detail below. In the full text of the specification of this application, the same or similar components and components with the same or similar functions are indicated by similar reference signs. The embodiments in related accompanying drawings described herein are descriptive and illustrative, and are used to provide a basic understanding of this application. The embodiments of this application shall not be construed as a limitation on this application.

The term “about” used herein are intended to describe and represent small variations. When used in combination with an event or a circumstance, the term may refer to an example in which the exact event or circumstance occurs or an example in which an extremely similar event or circumstance occurs. For example, when used in combination with a value, the term may refer to a variation range of less than or equal to ±10% of the value, for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, if a difference between two values is less than or equal to ±10% of an average value of the values (for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%), the two values may be considered “about” the same.

In this specification, unless otherwise specified or limited, a relative term such as “central”, “longitudinal”, “lateral”, “front”, “rear”, “right”, “left”, “internal”, “external”, “lower”, “higher”, “horizontal”, “vertical”, “higher than”, “lower than”, “above”, “below”, “top”, “bottom”, or their derivative terms (such as “horizontally”, “downwardly”, and “upwardly”) should be interpreted as a reference to a direction described in the discussion or depicted in the drawings. These relative terms are only used for ease of description, and do not require the construction or operation of this application in a specific direction.

Moreover, for ease of description, “first”, “second”, “third”, and the like may be used herein to distinguish different components in a drawing or a series of drawings. “First”, “second”, “third”, and the like are not intended to describe corresponding components.

In addition, quantities, ratios, and other values are sometimes presented in the format of ranges in this specification. It should be understood that such range formats are used for convenience and simplicity, and should be flexibly understood as including not only values clearly designated as falling within the range but also all individual values or sub-ranges covered by the range as if each value and sub-range are clearly designated.

In specific embodiments and claims, a list of items connected by the terms “one of”, “one piece of”, “one kind of” or other similar terms may mean any one of the listed items. For example, if items A and B are listed, the phrase “one of A and B” means only A or only B. In another example, if items A, B, and C are listed, the phrase “one of A, B, and C” means only A, only B, or only C. The item A may contain a single element or a plurality of elements. The item B may contain a single element or a plurality of elements. The item C may contain a single element or a plurality of elements.

In the specific embodiments and claims, an item list connected by the terms “at least one of”, “at least one piece of”, “at least one kind of” or other similar terms may mean any combination of the listed items. For example, if items A and B are listed, the phrase “at least one of A and B” means only A; only B; or A and B. In another example, if items A, B, and C are listed, the phrase “at least one of A, B, and C” means only A; only B; only C; A and B (exclusive of C); A and C (exclusive of B); B and C (exclusive of A); or all of A, B, and C. The item A may contain a single element or a plurality of elements. The item B may contain a single element or a plurality of elements. The item C may contain a single element or a plurality of elements.

The following definitions are used in this application (unless explicitly stated otherwise):

For simplicity, a “Cₙ₋ₘ” group refers to a group having “n” to “m” carbon atoms, where “n” and “m” are integers. For example, a “C₁₋₁₀” alkyl group is an alkyl group having 1 to 10 carbon atoms.

The term “alkyl group” is intended to be a straight-chain saturated hydrocarbon structure having 1 to 20 carbon atoms. The term “alkyl group” is also intended to be a branched or cyclic hydrocarbon structure having 3 to 20 carbon atoms. For example, the alkyl group may be an alkyl group having 1 to 20 carbon atoms, an alkyl group having 1 to 10 carbon atoms, an alkyl group having 1 to 5 carbon atoms, an alkyl group having 5 to 20 carbon atoms, an alkyl group having 5 to 15 carbon atoms, or an alkyl group having 5 to 10 carbon atoms. References to an alkyl group with a specific carbon number are intended to cover all geometric isomers with the specific carbon number. Therefore, for example, “butyl” is meant to include n-butyl, sec-butyl, isobutyl, tert-butyl, and cyclobutyl; and “propyl” includes n-propyl, isopropyl, and cyclopropyl. Examples of the alkyl group include, but are not limited to, a methyl group, an ethyl group, an n-propyl group, an isopropyl group, an cyclopropyl group, an n-butyl group, an isobutyl group, a sec-butyl group, a tert-butyl group, a cyclobutyl group, an n-pentyl group, an isopentyl group, a neopentyl group, a cyclopentyl group, a methylcyclopentyl group, an ethylcyclopentyl group, an n-hexyl group, an isohexyl group, a cyclohexyl group, an n-heptyl group, an octyl group, a cyclopropyl group, a cyclobutyl group, a norbornyl group, and the like. In addition, the alkyl group may be arbitrarily substituted.

The term “alkenyl group” refers to a straight-chain or branched monovalent unsaturated hydrocarbon group having at least one and usually 1, 2, or 3 carbon-carbon double bonds. Unless otherwise defined, the alkenyl group generally contains 2 to 20 carbon atoms. For example, the alkenyl group may be an alkenyl group having 2 to 20 carbon atoms, an alkenyl group having 6 to 20 carbon atoms, an alkenyl group having 2 to 10 carbon atoms, or an alkenyl group having 2 to 6 carbon atoms. Representative alkenyl groups include, for example, vinyl, n-propenyl, isopropenyl, n-but-2-enyl, but-3-enyl, and n-hex-3-enyl. In addition, the alkenyl group may be arbitrarily substituted.

The term “alkylidene group” means a divalent saturated alkyl group that may be straight-chain or branched. Unless otherwise defined, the alkylidene group generally contains 1 to 10, 1 to 6, 1 to 4, or 2 to 4 carbon atoms, and includes, for example, C₂₋₃ alkylidene group and C₂₋₆ alkylidene group. Representative alkylidene groups include, for example, methylene, ethane-1,2-diyl (“ethylene”), propane-1,2-diyl, propane-1,3-diyl, butane-1,4-diyl, and pentane-1,5-diyl.

The term “alkenylene group” means a bifunctional group obtained by removing one hydrogen atom from the above-defined alkenyl group. Preferably, the alkenylene group includes, but is not limited to, —CH═CH—, —C(CH₃)═CH—, —CH═CHCH₂—, and the like.

The term “cycloalkyl group” covers cyclic alkyl groups. The cycloalkyl group may be a cycloalkyl group having 2 to 20 carbon atoms, a cycloalkyl group having 6 to 20 carbon atoms, a cycloalkyl group having 2 to 10 carbon atoms, or a cycloalkyl group having 2 to 6 carbon atoms. For example, the cycloalkyl group may be cyclopropyl, cyclobutyl, cyclopentyl, cyclohexyl, or the like. In addition, the cycloalkyl group may be arbitrarily substituted.

The term “aryl group” means a monovalent aromatic hydrocarbon having a monocyclic (for example, phenyl) or fused ring. A fused ring system includes those ring systems that are fully unsaturated (for example, naphthalene) and those ring systems that are partially unsaturated (for example, 1,2,3,4-tetrahydronaphthalene). Unless otherwise defined, the aryl group generally contains 6 to 26, 6 to 20, 6 to 15, or 6 to 10 carbocyclic atoms, and includes, for example, a C₆₋₁₀ aryl group. Representative aryl groups include, for example, phenyl, methylphenyl, propylphenyl, isopropylphenyl, benzyl, naphth-1-yl, and naphth-2-yl.

The term “alkyl sulfonyl group” means a group —S(═O)₂—R, where R is the alkyl group as defined above.

The term “acyl group” means a group —C(═O)—R, where R is the alkyl group as defined above.

The term “heterocycle” or “heterocyclic group” means a substituted or unsubstituted 5 to 8-element monocyclic or bicyclic non-aromatic hydrocarbon, in which 1 to 3 carbon atoms are substituted with heteroatoms selected from nitrogen, oxygen or sulfur atoms. Examples include pyrrolidin-2-yl, pyrrolidin-3-yl, piperidinyl, morpholin-4-yl, or the like, which may be subsequently substituted. “Heteroatom” refers to an atom selected from N, O, and S.

As used herein, the term “halogen” may be F, Cl, Br, or I.

As used herein, the term “cyano group” covers organics containing an organic group —CN.

When the above substituents are substituted, the substituents may be selected from a group including halogen, an alkyl group, an alkenyl group, an aryl group, and a heteroaryl group.

### I. Electrolyte

1. Compound of Formula I and Lithium Difluorophosphate

This application provides an electrolyte, where the electrolyte includes a compound of formula I and lithium difluorophosphate,

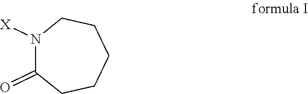

where X is selected from a substituted or unsubstituted C₁₋₁₀ alkyl group, a substituted or unsubstituted C₂₋₁₀ alkenyl group, a substituted or unsubstituted C₁₋₅ alkyl sulfonyl group, and a substituted or unsubstituted C₂₋₅ acyl group, and in the case of substitution, substituents include, but are not limited to, a cyano group, halogen, and the like.

In some embodiments, the compound of formula I is selected from at least one of N-acetylcaprolactam, N-vinylcaprolactam, N-methylcaprolactam, N-trifluoromethylcaprolactam, or N-methylsulfonylcaprolactam.

In some embodiments, based on a total weight of the electrolyte, a percentage of the compound of formula I ranges from 0.01% to 3%. For example, the percentage of the compound of formula I may be 0.01%, 0.1%, 0.5%, 1%, 1.5%, 2%, 2.5%, or 3%, or within a range between any two of the above values.

In some embodiments, based on a total weight of the electrolyte, a percentage of lithium difluorophosphate ranges from 0.01% to 1%. For example, the percentage of lithium difluorophosphate may be 0.01%, 0.1%, 0.2%, 0.3%, 0.4%, 0.49%, 0.5%, 0.6%, 0.7%, 0.8%, 0.9%, or 1%, or within a range between any two of the above values.

In some embodiments, based on a total weight of the electrolyte, a percentage of the compound of formula I ranges from 0.5% to 2%, and a percentage of lithium difluorophosphate may range from 0.1% to 0.5%. When the weight percentages of the compound of formula I and lithium difluorophosphate are within the above range, a combination thereof may significantly improve cycling stability and hot-box performance of electrochemical apparatuses.

In some embodiments, based on a total weight of the electrolyte, a percentage of the compound of formula I is a %, a percentage of lithium difluorophosphate is b %, and a ratio a/b of the compound of formula II to the lithium difluorophosphate in the electrolyte ranges from 0.01 to 30. For example, the ratio a/b of the compound of formula I to the lithium difluorophosphate in the electrolyte may be 0.01, 0.1, 1, 1.5, 1.6, 1.7, 2, 2.5, 3, 3.3, 3.5, 4, 5, 6, 6.5, 6.6, 6.7, 7, 8, 10, 15, 18, 20, 25, or 30, or within a range between any two of the above values. In some embodiments, a ratio a/b of the compound of formula I to the lithium difluorophosphate in the electrolyte ranges from 1.5 to 10. When the ratio is within the range, both room-temperature cycling performance and hot-box performance may be better improved.

The inventor of this application surprisingly found that, in addition to improving high-temperature storage performance, the above compound of formula I may also be used to improve safety performance of the electrochemical apparatuses. When the compound of formula I is used in combination with lithium difluorophosphate, a positive electrode and a negative electrode of a battery are more adequately protected, which is conducive to improving high-voltage stability and high-temperature stability of the battery, reducing impedance, and further improving the room-temperature cycling performance of the electrochemical apparatus and the hot-box performance of the battery.

2. First Additive

In some embodiments, the electrolyte of this application further includes a first additive. The first additive includes a compound of formula II:

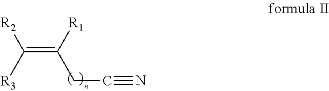

where R₁, R₂, and R₃ each are independently selected from hydrogen, halogen, a substituted or unsubstituted C₁₋₁₂ alkyl group, a substituted or unsubstituted C₃₋₈ cycloalkyl group, and a substituted or unsubstituted C₆₋₁₂ aryl group, and in the case of substitution, a substituent is selected from a cyano group, a nitro group, halogen, and a sulfonyl group, and n is an integer from 0 to 7. In formula II, the alkyl group, the cycloalkyl group, and the aryl group have the definitions defined above; and n may be 1, 2, 3, 4, 5, or 6.

In some embodiments, the compound of formula II includes at least one of acrylonitrile, butene nitrile, methacrylonitrile, 3-methyl butene nitrile, 2-pentene nitrile, 2-methyl-2 butene nitrile, or 2-methyl-2 pentene nitrile.

In some embodiments, based on a total weight of the electrolyte, a percentage of the first additive ranges from 0.01% to 5%, for example, may be 0.01%, 0.1%, 0.2%, 0.3%, 0.4%, 0.5%, 1%, 2%, 3%, 4%, or 5%, or within a range between any two of the above values. When the first additive is within the above range, a protective film may be more effectively formed on a negative electrode, thereby protecting the negative electrode and improving the high-temperature stability of the electrochemical apparatus.

3. Second Additive

In some embodiments, the electrolyte of this application further includes a second additive. The second additive includes a compound of formula III:

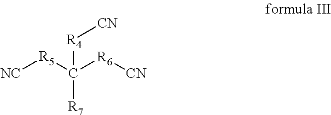

where R₄, R₅, R₆ are each independently selected from a substituted or unsubstituted C₁₋₁₂ alkylidene group, a substituted or unsubstituted C₂₋₁₂ alkenylene group, an R₀—S—R group, an R₀—O—R group, or an O—R group, and R₇ is selected from H, fluorine, cyano group, a substituted or unsubstituted C₁₋₁₂ alkyl group, a substituted or unsubstituted C₂₋₁₂ alkenyl group, an R₀—S—R group, an R₀—O—R group, or an O—R group, where R₀ and R are each independently selected from a substituted or unsubstituted C₁₋₆ alkenylene group; and in the case of substitution, a substituent is selected from halogen, a cyano group, a C₁₋₆ alkyl group, a C₂₋₆ alkenyl group, and any combination thereof.

In some embodiments, the compound of formula III in the electrolyte includes at least one of the following compounds:

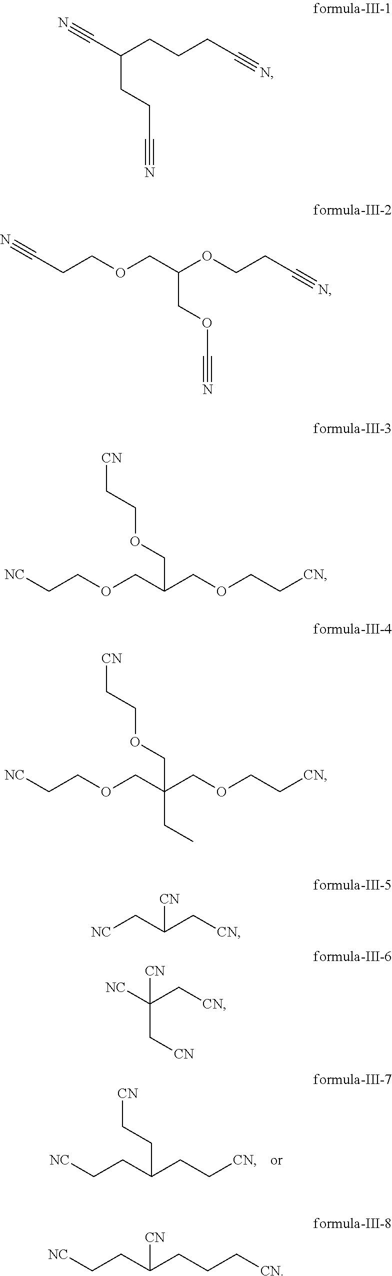

In some embodiments, based on a total weight of the electrolyte, a percentage of the second additive ranges from 0.1% to 5%, for example, may be 0.1%, 0.5%, 1%, 2%, 3%, 4%, or 5%, or within a range between any two of the above values. When the percentage of the compound of formula III is within the above range, the safety performance of the electrochemical apparatus may be better improved.

4. Third Additive

In some embodiments, the electrolyte of this application further includes a third additive. The third additive includes a dinitrile compound or an etherdinitrile compound.

In some embodiments, the third additive includes at least one of malononitrile, succinonitrile, glutaronitrile, adiponitrile, pimelonitrile, suberonitrile, azelanitrile, sebaconitrile, tetramethylsuccinonitrile, 2-methyl glutaronitrile, 2-methylene glutaronitrile, 2,4-dimethyl glutaronitrile, 2,2,4,4-tetramethyl glutaronitrile, or ethylene glycolbis(propionitrile)ether.

In some embodiments, based on a total weight of the electrolyte, a percentage of the third additive ranges from 1% to 8%, for example, may be 1%, 2%, 3%, 4%, 5%, 6%, 7%, or 8%, or within a range between any two of the above values.

In some embodiments, a percentage of the third additive in the electrolyte is not less than a percentage of the second additive. In some embodiments, a percentage of the third additive (the dinitrile compound or the etherdinitrile compound) is greater than a percentage of the second additive (the compound of formula III). When the percentage of the third additive is not less than the percentage of the second additive, the third additive can effectively inhibit a corrosion effect caused by the compound of formula III on a copper foil.

5. Fourth Additive

In some embodiments, the electrolyte of this application further includes a fourth additive. The fourth additive is selected from at least one of 1,3-propane sultone (PS), 1,3,2-Dioxathiolan-2,2-oxide (DTD), or fluoroethylene carbonate (FEC).

In some embodiments, based on a total weight of the electrolyte, a percentage of the fourth additive ranges from 0.10% to 10%, for example, may be 0.10%, 0.5%, 1%, 2%, 3%, 4%, 5%, 6%, 7%, 8%, 9%, or 10%, or within a range between any two of the above values.

6. Organic Solvent and Lithium Salt

In some embodiments, the electrolyte further includes an organic solvent and a lithium salt.

In some embodiments, the organic solvent includes at least one selected from ethylene carbonate (EC), propylene carbonate (PC), dimethyl carbonate (DMC), diethyl carbonate (DEC), ethyl methyl carbonate (EMC), gamma-butyrolactone (BL), methyl propionate (MP), ethyl acetate (EA), ethyl propionate (EP), or propyl propionate (PP). In some embodiments, the lithium salt includes at least one selected from lithium hexafluorophosphate (LiPF₆), lithium bis(trifluoromethanesulfonyl)imide (LiTFSI), lithium bis(fluorosulfonyl)imide (LiFSI), lithium tetrafluoroborate (LiBF₄), lithium bis(oxalato)borate (LiBOB), or lithium difluoro(oxalato)borate (LiDFOB).

### II. Electrochemical Apparatus

This application further provides an electrochemical apparatus, where the electrochemical apparatus includes an electrolyte according to this application. In some embodiments, the electrochemical apparatus according to this application includes, but is not limited to, a lithium-ion battery.

In some embodiments, the electrochemical apparatus includes a positive electrode, where the positive electrode includes:

a positive electrode current collector;

a positive electrode active material layer; and

an insulating layer, disposed on the positive electrode current collector and meeting at least one of condition (a), condition (b), or condition (c):

(a) a gap is reserved between the insulating layer and the positive electrode active material layer, where a width of the gap is less than or equal to 2 mm, for example, may be 0 mm, 0.5 mm, 1 mm, 1.5 mm, or 2 mm, or within a range between any two of the above values;

(b) the insulating layer includes inorganic particles, where the inorganic particles include at least one of aluminum oxide, silicon dioxide, magnesium oxide, titanium oxide, hafnium oxide, tin oxide, ceria oxide, nickel oxide, zinc oxide, calcium oxide, zirconium dioxide, yttrium oxide, silicon carbide, boehmite, aluminum hydroxide, magnesium hydroxide, calcium hydroxide, or barium sulfate; and

(c) the insulating layer includes a polymer, where the polymer includes at least one of a homopolymer of polyvinylidene fluoride, a copolymer of polyvinylidene fluoride, a copolymer of hexafluoropropylene, polystyrene, polyphenylacetylene, polyvinyl sodium, polyvinyl potassium, polymethyl methacrylate, polyethylene, polypropylene, or polytetrafluoroethylene.

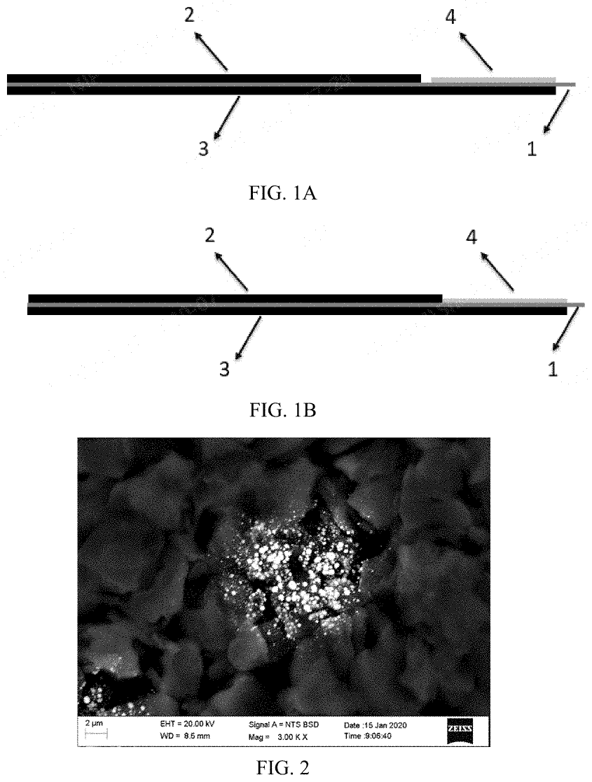

In some embodiments, the insulating layer meets the above condition (a). Specifically, as shown in FIG. 1A and FIG. 1B, the positive electrode includes a positive electrode current collector (1), a first-surface positive electrode active substance layer (2), a second-surface active substance layer (3), and an insulating layer (4), where in addition to an area covered with the active substance layer, the positive electrode current collector also includes an area not covered with the active substance layer (also referred to as a foil free zone). The first-surface positive electrode active substance layer (2) is shorter than the second-surface active substance layer (3). The insulating layer (4) is in the foil free zone on the same side of the first-surface positive electrode active substance layer on the current collector. A gap about 0 mm to 2 mm is reserved between one end of the insulating layer and the first-surface active substance layer. The positive electrode generally includes a positive electrode current collector, a positive electrode active substance layer, and the like. In a thermal abuse test, an aluminum current collector has a higher potential and is prone to generating much heat by contact with the electrolyte. Therefore, with an insulating layer disposed on the foil free zone, the foil free zone of the positive electrode current collector in the positive electrode may be effectively protected, and a direct contact with the electrolyte may be reduced, which is conductive to reducing heat generation. With a combination of the positive electrode meeting the condition (a) and the electrolyte according to this application, the overall thermal stability of the battery is improved, further increasing a pass temperature of the hot-box.

In some embodiments, a thickness of the insulating layer ranges from 1 μm to 20 μm, for example, may be 1 μm, 2.5 μm, 5 μm, 7.5 μm, 10 μm, 12 μm, 14 μm, 16 μm, 18 μm, or 20 μm, or within a range between any two of the above values.

In this application, specific types of the positive electrode active materials are not particularly limited and may be selected according to requirements, and specifically, may be selected from at least one of a ternary material such as lithium cobalt oxide (LiCoO₂), lithium nickel cobalt manganese (NCM), and lithium nickel cobalt aluminum (NCA), lithium iron phosphate (LiFePO₄), or lithium manganate (LiMn₂O₄).

In some embodiments, the electrochemical apparatus further includes a negative electrode. The negative electrode includes a negative electrode current collector and a negative electrode active material layer. In this application, the negative electrode active material is not limited to a specific type, and may be selected based on needs. Specifically, the negative electrode active material may be selected from at least one of lithium metal, structured lithium metal, natural graphite, artificial graphite, mesocarbon microbeads (MCMB for short), hard carbon, soft carbon, silicon, a silicon-carbon composite, a Li—Sn alloy, a Li—Sn—O alloy, Sn, SnO, SnO₂, spinel-structure lithiated TiO₂—Li₄Ti₅O₁₂, or a Li—Al alloy.

In some embodiments, the electrochemical apparatus further includes a separator. The separator material is not limited to a specific type, and may be selected based on needs. Specifically, the separator may be selected from a polyethylene film, a polypropylene film, a polyvinylidene fluoride film, or multilayer composite film thereof. Or, a surface of the separator substrate may be coated with an inorganic or organic material according to actual requirements to enhance hardness of the battery or to improve bonding performance between the separator and an interface that is between the positive electrode and negative electrodes.

### III. Electronic Apparatus

This application further provides an electronic apparatus, where the electronic apparatus includes an electrochemical apparatus according to this application.

The type of the electronic apparatus of this application is not specifically limited. In some embodiments, the electronic apparatus of this application may be used for, but is not limited to, a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a memory card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, a lithium-ion capacitor, or the like.

### Examples

This application is further described with reference to Examples. It should be understood that these Examples are merely used to describe this application but not to limit the scope of this application.

1. Preparation Method

In Examples and Comparative Examples, lithium-ion batteries were all prepared according to the following method:

(1) Preparation of an Electrolyte

In a glove box under argon atmosphere with water content less than 10 ppm, ethylene carbonate (EC), propylene carbonate (PC), and diethyl carbonate (DEC) were mixed evenly at a weight ratio of 1:1:1, and lithium hexafluorophosphate (LiPF₆) was added and stirred well, so that a basic electrolyte was obtained, where a concentration of LiPF₆ was 1.15 mol/L. In the basic electrolyte, other additives were added according to the amount and type provided in the table below to obtain electrolytes in various Examples and Comparative examples.

(2) Preparation of a Positive Electrode

A positive electrode active material lithium cobalt oxide (LiCoO₂), a conductive agent carbon nanotubes (CNT), and a binder polyvinylidene fluoride were mixed at a weight ratio of 95:2:3, and N-methylpyrrolidone (NMP) was added. Then the mixture was stirred well under the action of a vacuum mixer to obtain a uniform positive electrode slurry, and the positive electrode slurry was uniformly applied onto a positive electrode current collector aluminum foil. The aluminum foil was dried at 85° C., followed by cold pressing to obtain a positive electrode active material layer, which was then subjected to cutting, slitting, and tab welding, and then dried under vacuum at 85° C. for 4 hours, to obtain a positive electrode.

(3) Preparation of a Negative Electrode

A negative electrode active material graphite, styrene-butadiene rubber (SBR), and sodium carboxymethyl cellulose (CMC) were fully stirred and mixed in an appropriate amount of deionized water solvent at a weight ratio of 95:2:3, to form a uniform negative electrode slurry; and the slurry was applied onto a negative electrode current collector copper foil, followed by drying and cold pressing, to obtain a negative electrode active material layer, which was subjected to cutting, slitting and tab welding, and then dried at 85° C. for 4 hours under vacuum, so as to obtain the negative electrode.

(4) Preparation of a Separator

A polyethylene (PE) film was used as the separator.

(5) Preparation of a Lithium-Ion Battery

A positive electrode, a separator, and a negative electrode were laminated in order, so that the separator was located between the positive electrode and the negative electrode for isolation, followed by winding and being placed in an outer packaging foil; the electrolyte prepared according to each Example and each Comparative example was injected into a dried battery to complete the preparation of the lithium-ion battery after processes such as vacuum packaging, standing, chemical conversion, and shaping.

2. Test Method

(1) Test Method for Room-Temperature Cycling Capacity Retention Rate of the Lithium-Ion Battery

At 25° C., the lithium-ion battery was charged at a constant current of 0.7 C to 4.45 V, then charged at a constant voltage of 4.45 V to a current of 0.05 C, and then discharged at a constant current of 1 C to 3.0 V. This was the first cycle. A discharge capacity at the first cycle was recorded. The foregoing steps for the lithium-ion battery were cycled many times under the foregoing conditions. The first discharge capacity was taken as 100%, the charge and discharge cycle was repeated until the discharge capacity was decayed to 80%, then the test was stopped, and the number of cycles at 25° C. was recorded as an indicator to evaluate the cycling performance of the lithium-ion battery.

(2) Hot-Box Test

At 25° C., the lithium-ion battery was charged at a constant current of 0.7 C to 4.45 V, and then charged at a constant voltage of 4.45 V to a current of 0.05 C. The battery was placed in a high-temperature box, heated to 135° C. with a temperature rise rate of 5±2° C./min, and then kept for 1 hour. The battery passed the test if there was no fire, no explosion, or no smoke. Each group of 10 batteries were tested, and the number of batteries that passed the test was recorded.

(3) High-Temperature Storage Test

After standing for 30 min at 25° C., the lithium-ion battery was charged at a constant current rate of 0.5 C to 4.45 V, then charged at a constant voltage of 4.45 V to 0.05 C, and then left standing for 5 min, and a thickness of the lithium-ion battery was measured and denoted as H₀. Then, the lithium-ion battery was placed in an incubator at 85° C. and stored for 24 days, followed by measuring the thickness of the lithium-ion battery, which was denoted as H₁. A volume swelling rate of the lithium-ion battery was calculated according to the following formula: volume swelling rate (%)=(H₁−H₀)/H₀×100%.

(4) Copper Precipitation Test on the Negative Electrode

A small piece of sample was taken from the negative electrode, and placed in a scanning electron microscope which was used with an energy dispersive spectrometer, to characterize element types and identify whether there was a large amount of copper. As shown in FIG. 2, in the scanning electron microscope, if there was a luminous area (namely, a copper precipitation area) in the negative electrode, it was considered that there was copper precipitation.

3. Test Result

(1) Influence of the Compound of Formula I and LiPO₂F₂ on Battery Performance

Table 1 provides data and test results of Examples 1-1 to 1-18 and Comparative Examples 1-1 to 1-8. The percentages of the compound of formula I and lithium difluorophosphate in Table 1 were wt % based on the total weight of the electrolyte.

TABLE 1

| | | | | | Ratio of | | Number of |
|---|---|---|---|---|---|---|---|
| | Compound of formula 1 | | | | compound of | Number | batteries that |
| | N-vinylcaprolactam | N-acetyleaprolactam | N-methylcaprolactam | LiPO₂F₂ | formula I to | of cycles | passed hot- |
| Number | (wt %) | (wt %) | (wt %) | (wt %) | LiPO₂F₂ | at 25° C. | box test |
| Comparative | 0 | 0 | 0 | 0 | / | 480 | 2 |
| Example 1-1 | | | | | | | |
| Comparative | 0.5 | 0 | 0 | 0 | / | 490 | 3 |
| Example 1-2 | | | | | | | |
| Comparative | 0 | 0.5 | 0 | 0 | / | 493 | 3 |
| Example 1-3 | | | | | | | |
| Comparative | 0 | 1 | 0 | 0 | / | 495 | 4 |
| Example 1-4 | | | | | | | |
| Comparative | 0 | 0 | 0.5 | 0 | / | 485 | 3 |
| Example 1-5 | | | | | | | |
| Comparative | 0 | 0 | 0 | 0.1 | 0 | 484 | 3 |
| Example 1-6 | | | | | | | |
| Comparative | 0 | 0 | 0 | 0.3 | 0 | 500 | 4 |
| Example 1-7 | | | | | | | |
| Comparative | 0 | 0 | 0 | 0.5 | 0 | 500 | 4 |
| Example 1-8 | | | | | | | |
| Example 1-1 | 0.5 | 0 | 0 | 0.3 | 1.67 | 538 | 7 |
| Example 1-2 | 0 | 0.01 | 0 | 0.3 | 0.033 | 514 | 5 |
| Example 1-3 | 0 | 0.1 | 0 | 0.3 | 0.33 | 526 | 6 |
| Example 1-4 | 0 | 0.5 | 0 | 0.1 | 5 | 535 | 7 |
| Example 1-5 | 0 | 0.5 | 0 | 0.3 | 1.67 | 545 | 9 |
| Example 1-6 | 0 | 1 | 0 | 0.3 | 3.33 | 545 | 10 |
| Example 1-7 | 0 | 2 | 0 | 0.3 | 6.67 | 536 | 10 |
| Example 1-8 | 0 | 3 | 0 | 0.3 | 10 | 521 | 10 |
| Example 1-9 | 0 | 3 | 0 | 0.15 | 20 | 517 | 10 |
| Example 1-10 | 0 | 3 | 0 | 0.1 | 30 | 511 | 9 |
| Example 1-11 | 0 | 2.5 | 0 | 0.08 | 31.25 | 507 | 9 |
| Example 1-12 | 0 | 3.1 | 0 | 0.1 | 33 | 501 | 8 |
| Example 1-13 | 0 | 0.5 | 0 | 0.5 | 1 | 556 | 10 |
| Example 1-14 | 0 | 0.5 | 0 | 0.7 | 0.71 | 535 | 9 |
| Example 1-15 | 0 | 0.5 | 0 | 1 | 0.5 | 523 | 8 |
| Example 1-16 | 0 | 0.5 | 0 | 2 | 0.25 | 517 | 8 |
| Example 1-17 | 0 | 0 | 0.5 | 0.3 | 1.67 | 537 | 8 |
| Example 1-18 | 0 | 0 | 1 | 0.3 | 3.33 | 530 | 8 |

As shown in Table 1, it can be seen from test results of the above Comparative examples and Examples that the combination of the compound of formula I and LiPO₂F₂ may unexpectedly improve the cycling stability of the number of cycles at 25° C. and increase the pass rate of the batteries in hot-box test. The compound of formula I had a higher reduction potential and can preferentially form a film on the negative electrode. LiPO₂F₂ had a protective effect on both the positive electrode and the negative electrode. When the compound of formula I and LiPO₂F₂ were present at the same time, the positive electrode and the negative electrode of the battery can be more adequately protected, which was conductive to improving the high-voltage stability and high-temperature stability of the battery, thereby improving the cycling performance at 25° C. and the pass rate of the batteries in hot-box test. When the ratio of the compound of formula I to LiPO₂F₂ ranged from 0.01 to 30, the battery can achieve more excellent performance.

(2) Influence of a First Additive on Battery Performance

The electrolyte of this application further included a first additive, where the first additive included a compound of formula II. Table 2 provides data and test results of Examples 2-1 to 2-9 and Comparative examples 1-1, 2-1, and 2-2. The weight percentages of N-acetylcaprolactam, lithium difluorophosphate, and the first additive in Table 2 were based on the total weight of the electrolyte.

TABLE 2

| | | | | | | Number of |
|---|---|---|---|---|---|---|
| | | | First additive | | Number of | batteries that |
| | N-acetylcaprolactam | | Acrylonitrile | Butenenitrile | cycles at | passed hot-box |
| Number | (wt %) | LiPO₂F₂ (%) | (wt %) | (wt %) | 25° C. | test |
| Comparative | 0 | 0 | 0 | 0 | 480 | 2 |
| Example 1-1 | | | | | | |
| Comparative | 0 | 0 | 0.5 | 0 | 486 | 3 |
| Example 2-1 | | | | | | |
| Comparative | 0 | 0 | 0 | 0.5 | 500 | 4 |
| Example 2-2 | | | | | | |
| Example 1-4 | 0.5 | 0.1 | 0 | 0 | 535 | 7 |
| Example 2-1 | 0.5 | 0.1 | 0.5 | 0 | 543 | 9 |
| Example 2-2 | 0.5 | 0.1 | 0 | 0.5 | 545 | 10 |
| Example 2-3 | 0.5 | 0.3 | 0 | 0.5 | 557 | 10 |
| Example 2-4 | 0.5 | 0.1 | 0.2 | 0.3 | 553 | 10 |
| Example 2-5 | 0.5 | 0.1 | 0 | 0.1 | 538 | 8 |
| Example 2-6 | 0.5 | 0.1 | 0 | 0.3 | 540 | 9 |
| Example 2-7 | 0.5 | 0.1 | 0 | 0.7 | 553 | 10 |
| Example 2-8 | 0.5 | 0.1 | 0 | 1 | 550 | 10 |
| Example 2-9 | 0.5 | 0.1 | 0 | 0 | 537 | 9 |

As shown in Table 2, when the electrolyte further included the first additive, more excellent cycling performance and safety performance were achieved. This was because: the compound of formula II contained a cyano functional group and a double bond at the same time, which can protect the positive electrode and the negative electrode at the same time; the combination of the compound of formula II and LiPO₂F₂ can synergistically play a protective effect on the interface of the positive electrode and the negative electrode, thereby further improving the stability of the interface between the positive electrode and the negative electrode, and further improving the electrical performance and safety performance.

3. Influence of a Second Additive on Battery Performance

The electrolyte according to this application further included a second additive, where the second additive included a compound of formula III. Table 3 provides data and test results of Examples 3-1 to 3-8 and Comparative examples 1-1, 3-1, and 3-2. The weight percentages of N-acetylcaprolactam, lithium difluorophosphate, and the second additive in Table 3 are based on the total weight of the electrolyte.

TABLE 3

| | | | | | | Number of |
|---|---|---|---|---|---|---|
| | | | Second additive | | Number of | batteries that |
| | N-acetylcaprolactam | LiPO₂F₂ | Formula III-1 | Formula III-2 | cycles at | passed hot- |
| Number | (wt %) | (%) | (wt %) | (wt %) | 25° C. | box test |
| Comparative Example 1-1 | 0 | 0 | 0 | 0 | 480 | 0 |
| Comparative Example 3-1 | 0 | 0 | 1 | 0 | 496 | 4 |
| Comparative Example 3-2 | 0 | 0 | 0 | 1 | 500 | 4 |
| Example 1-4 | 0.5 | 0.1 | 0 | 0 | 535 | 7 |
| Example 3-1 | 0.5 | 0.1 | 1 | 0 | 550 | 10 |
| Example 3-2 | 0.5 | 0.1 | 0 | 1 | 545 | 10 |
| Example 3-3 | 0.5 | 0.1 | 0.5 | 0.5 | 556 | 10 |
| Example 3-4 | 0.5 | 0.1 | 0.1 | 0 | 542 | 7 |
| Example 3-5 | 0.5 | 0.1 | 1 | 0 | 557 | 9 |
| Example 3-6 | 0.5 | 0.1 | 1 | 1 | 551 | 10 |
| Example 3-7 | 0.5 | 0.1 | 3 | 0 | 548 | 10 |
| Example 3-8 | 0.5 | 0.1 | 5 | 0 | 540 | 9 |

As shown in Table 3, when the electrolyte further included the second additive, its capability of passing hot-box test may be further improved, which was mainly due to a combined action of the compound of formula I, LiPO₂F₂, and the second additive, and the protection to the positive electrode was further improved. During the thermal abuse test of the battery, the stability of the positive electrode played an important role in the overall thermal stability of the battery.

(4) Influence of Nitrile Additives on Corrosion of Copper Foil

The electrolyte of this application may include both the second additive and the third additive. Table 4 provides data and test results of Examples 4-1 to 4-9 and Comparative example 4-1. The weight percentages of N-acetylcaprolactam, lithium difluorophosphate, the second additive, and the third additive in Table 4 were based on the total weight of the electrolyte.

TABLE 4

| | | | | | | | High- |
|---|---|---|---|---|---|---|---|
| | | | | | | Negative | temperature |
| | | | Third additive | | | electrode has | storage |
| | N- | | | Weight | Second additive | copper | thickness |
| | acetylcaprolactam | LiPO₂F₂ | | percentage | Formula III-1 | precipitation | swelling rate |
| Number | (wt %) | (%) | Composition | (wt %) | (wt %) | in EDS? | at 85° C. |
| Comparative | 0 | 0 | | 0 | 0 | No | 20% |
| Example 4-1 | | | | | | | |
| Example 1-4 | 0.5 | 0.1 | 0 | 0 | 0 | No | 19% |
| Example 4-1 | 0.5 | 0.1 | Adiponitrile | 2 | 0 | No | 17% |
| Example 4-2 | 0.5 | 0.1 | Adiponitrile | 2 | 1 | No | 15% |
| Example 4-3 | 0.5 | 0.1 | Adiponitrile | 2 | 2 | No | 10% |
| Example 4-4 | 0.5 | 0.1 | Adiponitrile | 1 | 2 | Yes | 11% |
| Example 4-5 | 0.5 | 0.1 | Butanedinitrile | 2 | 1 | No | 14% |
| Example 4-6 | 0.5 | 0.1 | Adiponitrile + Ethylene | 1 + 1 | 1 | No | 13% |
| | | | glycolbis(propionitrile)ether | | | | |
| Example 4-7 | 0.5 | 0.1 | Adiponitrile + Ethylene | 2 + 2 | 0.5 | No | 12% |
| | | | glycolbis(propionitrile)ether | | | | |
| Example 4-8 | 0.5 | 0.1 | Adiponitrile + Ethylene | 2 + 1 | 0.5 | No | 10% |
| | | | glycolbis(propionitrile)ether | | | | |
| Example 4-9 | 0.5 | 0.1 | Adiponitrile + Ethylene | 4 + 3 | 1 | No | 9% |
| | | | glycolbis(propionitrile)ether | | | | |
| Example 4-10 | 0.5 | 0.1 | / | 0 | 7 | Yes | 13% |
| Example 4-11 | 0.5 | 0.1 | Adiponitrile + Ethylene | 1 + 1 | 0 | No | 15% |
| | | | glycolbis(propionitrile)ether | | | | |
| Example 4-12 | 0.5 | 0.1 | Adiponitrile | 3 | 0 | No | 15% |
| Example 4-13 | 0.5 | 0.1 | Adiponitrile + | 2 + 1 | 0 | No | 14% |
| | | | Butanedinitrile | | | | |

It can be seen from results shown in the above table that the ratio between the third additive and the second additive had a significant effect on inhibiting the copper foil corrosion. Through the comparison of Examples 4-1 to 4-13, it can be found that the use of the second additive alone would enhance the corrosion effect on the copper foil, and the addition of the third additive would reduce the corrosion of the copper foil to a certain extent; and when the amount of the third additive was not less than the amount of the second additive, the corrosion of the copper foil can be avoided.

(5) Influence of the Positive Electrode Insulating Layer on Battery Performance

The positive electrode in the electrochemical apparatus of this application may include an insulating layer. Table 5 below shows the influence of the positive electrode insulating layer on the battery performance.

TABLE 5

| | | | | | | Number |
|---|---|---|---|---|---|---|
| | Positive | | | | | of |
| | electrode | | | | Number | batteries |
| | plate | | | | of | that |
| | with | Gap | N- | | cycles | passed |
| Sample | insulation | width | acetylcaprolactam | LiPO₂F₂ | at | hot-box |
| name | coating? | (mm) | (wt %) | (%) | 25° C. | test |
| Example | No | 0 | 0.5 | 0.1 | 535 | 7 |
| 1-4 | | | | | | |
| Example | Yes | 1 | 0.5 | 0.1 | 536 | 10 |
| 5-1 | | | | | | |
| Example | Yes | 0 | 0.5 | 0.1 | 537 | 10 |
| 5-2 | | | | | | |

In Example 5-1, the insulating layer is located in the foil free zone on the same side of the first-surface positive electrode active material layer, and a gap of 1 mm is reserved between the insulating layer and the first-surface active material layer; in the insulating layer, the inorganic particles are aluminum oxide, and the polymer is a homopolymer of polyvinylidene fluoride with a thickness of 10 μm. In Example 5-2, the inorganic particles are magnesium oxide, and the polymer is a homopolymer of polyvinylidene fluoride with a thickness of 10 μm.

Through comparison of data in Table 5, it could be unexpectedly found that the existence of the insulating layer can improve the thermal stability of the battery without any deterioration in other electrical performance. At present, the action mechanism of the insulating layer is not clear. It is supposed that the existence of the insulating layer may reduce the exposure of a metal aluminum substrate and reduce its contact with the electrolyte. The positive electrode of the battery in a fully charged state is in a high potential state, metal aluminum that is in a high potential correspondingly is prone to chemical reaction when in contact with the electrolyte, which increases heat generation. Therefore, by reducing the exposure of the substrate, heat generation may be reduced to a certain extent so as to increase the pass rate in hot-box test.

References to “some embodiments”, “some of the embodiments”, “an embodiment”, “another example”, “examples”, “specific examples”, or “some examples” in the specification mean the inclusion of specific features, structures, materials, or characteristics described in at least one embodiment or example of this application in the embodiment or example. Therefore, descriptions in various places throughout the specification, such as “in some embodiments”, “in the embodiments”, “in an embodiment”, “in another example”, “in an example”, “in a specific example”, or “examples”, do not necessarily refer to the same embodiment or example in this application. In addition, a specific feature, structure, material, or characteristic herein may be combined in any appropriate manner in one or more embodiments or examples.

Although illustrative embodiments have been demonstrated and described, a person skilled in the art should understand that the foregoing embodiments are not to be construed as limiting this application, and that the embodiments may be changed, replaced, and modified without departing from the spirit, principle, and scope of this application.

What is claimed is:

1. An electrolyte, comprising a compound of formula I and lithium difluorophosphate, 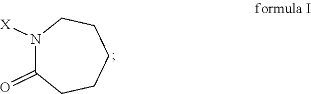
wherein X is selected from the group consisting of a substituted or unsubstituted C₁₋₁₀ alkyl group, a substituted or unsubstituted C₂₋₁₀ alkenyl group, a substituted or unsubstituted C₁₋₅ alkyl sulfonyl group, and a substituted or unsubstituted C₂₋₅ acyl group; and in the case of substitution, a substituent is selected from a cyano group or a halogen.

2. The electrolyte according to claim 1, wherein the compound of formula I is at least one selected from N-acetylcaprolactam, N-vinylcaprolactam, N-methylcaprolactam, N-trifluoromethylcaprolactam, or N-methylsulfonylcaprolactam.

3. The electrolyte according to claim 1, wherein based on a total weight of the electrolyte, a percentage of the compound of formula I ranges from 0.01% to 3%, and a percentage of the lithium difluorophosphate ranges from 0.01% to 1%.

4. The electrolyte according to claim 1, wherein based on a total weight of the electrolyte, a percentage of the compound of formula I is a %, a percentage of the lithium difluorophosphate is b %, and a ratio a/b of the compound of formula I to the lithium difluorophosphate ranges from 0.01 to 30.

5. The electrolyte according to claim 1, further comprising at least one of the following compounds:
(1) a first additive, wherein the first additive includes a compound of formula II, and based on a total weight of the electrolyte, a percentage of the first additive ranges from 0.01% to 5%: 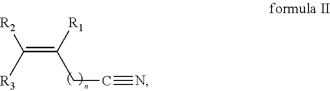
wherein R₁, R₂, and R₃ each are independently selected from hydrogen, halogen, a substituted or unsubstituted C₁₋₁₂ alkyl group, a substituted or unsubstituted C₃₋₈ cycloalkyl group, and a substituted or unsubstituted C₆₋₁₂ aryl group, and in the case of substitution, a substituent is selected from a cyano group, a nitro group, halogen, and a sulfonyl group, and n is an integer from 0 to 7;
(2) a second additive, wherein the second additive includes a compound of formula III, and based on a total weight of the electrolyte, a percentage of the second additive ranges from 0.10% to 5%: 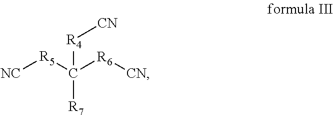
wherein R₄, R₅, R₆ are each independently selected from a substituted or unsubstituted C₁₋₁₂ alkylidene group, a substituted or unsubstituted C₂₋₁₂ alkenylene group, an R₀—S—R group, an R₀—O—R group, or an O—R group, and R₇ is selected from H, fluorine, a cyano group, a substituted or unsubstituted C₁₋₁₂ alkyl group, a substituted or unsubstituted C₂₋₁₂ alkenyl group, an R₀—S—R group, an R₀—O—R group, or an O—R group, where R₀ and R are each independently selected from a substituted or unsubstituted C₁₋₆ alkenylene group; and in the case of substitution, a substituent is selected from halogen, a cyano group, a C₁₋₆ alkyl group, a C₂₋₆ alkenyl group, and any combination thereof;
(3) a third additive, wherein the third additive includes a dinitrile compound or an ether dinitrile compound, and based on a total weight of the electrolyte, a percentage of the third additive ranges from 1% to 8%; and
(4) a fourth additive, wherein the fourth additive comprises at least one of 1,3-propanesultone, ethylene sulfate, or fluoroethylene carbonate, and based on a total weight of the electrolyte, a percentage of the fourth additive ranges from 0.1% to 10%.

6. The electrolyte according to claim 5, wherein
the compound of formula II comprises at least one of acrylonitrile, butene nitrile, methacrylonitrile, 3-methyl butene nitrile, 2-pentene nitrile, 2-methyl-2 butene nitrile, or 2-methyl-2 pentene nitrile;
the compound of formula III comprises at least one of the following compounds: 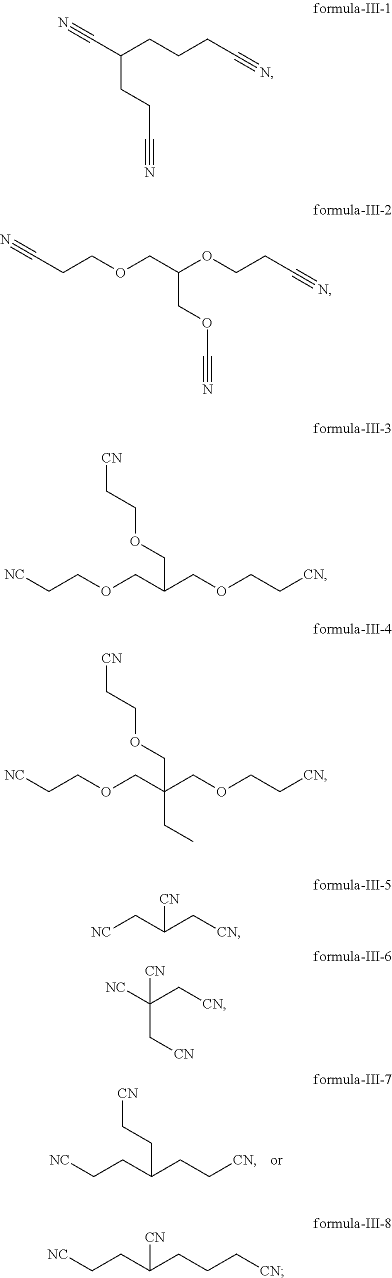
the dinitrile compound or etherdinitrile compound includes at least one of malononitrile, succinonitrile, glutaronitrile, adiponitrile, pimelonitrile, suberonitrile, azelanitrile, sebaconitrile, tetramethylsuccinonitrile, 2-methyl glutaronitrile, 2-methylene glutaronitrile, 2,4-dimethyl glutaronitrile, 2,2,4,4-tetramethyl glutaronitrile, or ethylene glycolbis(propionitrile)ether.

7. The electrolyte according to claim 1, further comprising an organic solvent and a lithium salt, wherein the organic solvent comprises at least one selected from ethylene carbonate, propylene carbonate, dimethyl carbonate, diethyl carbonate, ethyl methyl carbonate, ethyl acetate, methyl propionate, ethyl propionate, or propyl propionate; the lithium salt comprises at least one selected from lithium hexafluorophosphate, lithium bis(trifluoromethanesulfonyl)imide, lithium bis(fluorosulfonyl)imide, lithium tetrafluoroborate, lithium bis(oxalato)borate, or lithium difluoro(oxalato)borate.

8. An electrochemical apparatus, comprising an electrolyte, the electrolyte comprises a compound of formula I and lithium difluorophosphate, 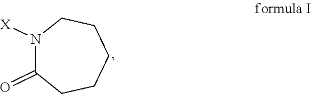
wherein X is selected from the group consisting of a substituted or unsubstituted C₁₋₁₀ alkyl group, a substituted or unsubstituted C₂₋₁₀ alkenyl group, a substituted or unsubstituted C₁₋₅ alkyl sulfonyl group, and a substituted or unsubstituted C₂₋₅ acyl group, and in the case of substitution, a substituent is selected from a cyano group and halogen.

9. The electrochemical apparatus according to claim 8, wherein the compound of formula I is at least one selected from N-acetylcaprolactam, N-vinylcaprolactam, N-methylcaprolactam, N-trifluoromethylcaprolactam, or N-methylsulfonylcaprolactam.

10. The electrochemical apparatus according to claim 8, wherein based on a total weight of the electrolyte, a percentage of the compound of formula I ranges from 0.01% to 3%, and a percentage of the lithium difluorophosphate ranges from 0.01% to 1%.

11. The electrochemical apparatus according to claim 8, wherein based on a total weight of the electrolyte, a percentage of the compound of formula I is a %, a percentage of the lithium difluorophosphate is b %, and a ratio a/b of the compound of formula I to the lithium difluorophosphate ranges from 0.01 to 30.

12. The electrochemical apparatus according to claim 8, further comprising at least one of the following compounds:
(1) a first additive, wherein the first additive includes a compound of formula II, and based on a total weight of the electrolyte, a percentage of the first additive ranges from 0.01% to 5%: 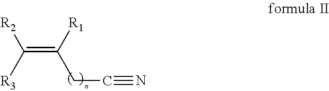
wherein R₁, R₂, and R₃ each are independently selected from hydrogen, halogen, a substituted or unsubstituted C₁₋₁₂ alkyl group, a substituted or unsubstituted C₃₋₈ cycloalkyl group, and a substituted or unsubstituted C₆₋₁₂ aryl group, and in the case of substitution, a substituent is selected from a cyano group, a nitro group, halogen, and a sulfonyl group, and n is an integer from 0 to 7;
(2) a second additive, wherein the second additive includes a compound of formula III, and based on a total weight of the electrolyte, a percentage of the second additive ranges from 0.1% to 5%: 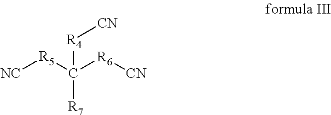
wherein R₄, R₅, R₆ are each independently selected from a substituted or unsubstituted C₁₋₁₂ alkylidene group, a substituted or unsubstituted C₂₋₁₂ alkenylene group, an R₀—S—R group, an R₀—O—R group, or an O—R group, and R₇ is selected from H, fluorine, a cyano group, a substituted or unsubstituted C₁₋₁₂ alkyl group, a substituted or unsubstituted C₂₋₁₂ alkenyl group, an R₀—S—R group, an R₀—O—R group, or an O—R group, where R₀ and R are each independently selected from a substituted or unsubstituted C₁₋₆ alkenylene group; and in the case of substitution, a substituent is selected from halogen, a cyano group, a C₁₋₆ alkyl group, a C₂₋₆ alkenyl group, and any combination thereof;
(3) a third additive, wherein the third additive includes a dinitrile compound or an ether dinitrile compound, and based on a total weight of the electrolyte, a percentage of the third additive ranges from 1% to 8%; and
(4) a fourth additive, wherein the fourth additive comprises at least one of 1,3-propanesultone, ethylene sulfate, or fluoroethylene carbonate, and based on a total weight of the electrolyte, a percentage of the fourth additive ranges from 0.10% to 10%.

13. The electrochemical apparatus according to claim 12, wherein
the compound of formula II comprises at least one of acrylonitrile, butene nitrile, methacrylonitrile, 3-methyl butene nitrile, 2-pentene nitrile, 2-methyl-2 butene nitrile, or 2-methyl-2 pentene nitrile;
the compound of formula III comprises at least one of the following compounds: 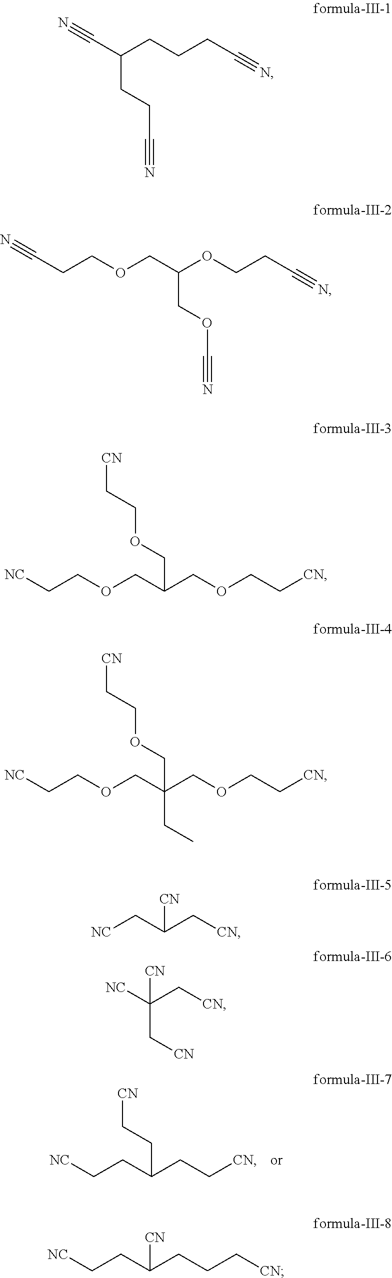
the dinitrile compound or etherdinitrile compound includes at least one of malononitrile, succinonitrile, glutaronitrile, adiponitrile, pimelonitrile, suberonitrile, azelanitrile, sebaconitrile, tetramethylsuccinonitrile, 2-methyl glutaronitrile, 2-methylene glutaronitrile, 2,4-dimethyl glutaronitrile, 2,2,4,4-tetramethyl glutaronitrile, or ethylene glycolbis(propionitrile)ether.

14. The electrochemical apparatus according to claim 8, further comprising an organic solvent and a lithium salt, wherein the organic solvent comprises at least one selected from ethylene carbonate, propylene carbonate, dimethyl carbonate, diethyl carbonate, ethyl methyl carbonate, ethyl acetate, methyl propionate, ethyl propionate, or propyl propionate; the lithium salt comprises at least one selected from lithium hexafluorophosphate, lithium bis(trifluoromethanesulfonyl)imide, lithium bis(fluorosulfonyl)imide, lithium tetrafluoroborate, lithium bis(oxalato)borate, or lithium difluoro(oxalato)borate.

15. The electrochemical apparatus according to claim 8, further comprising a positive electrode, wherein the positive electrode comprises:
a positive electrode current collector;
a positive electrode active material layer; and
an insulating layer disposed on the positive electrode current collector and meeting at least one of condition (a), condition (b), or condition (c):
(a) a gap is provided between the insulating layer and the positive electrode active material layer, a width of the gap being less than or equal to 2 mm;
(b) the insulating layer comprises inorganic particles, wherein the inorganic particles comprise at least one of aluminum oxide, silicon dioxide, magnesium oxide, titanium oxide, hafnium oxide, tin oxide, ceria oxide, nickel oxide, zinc oxide, calcium oxide, zirconium dioxide, yttrium oxide, silicon carbide, boehmite, aluminum hydroxide, magnesium hydroxide, calcium hydroxide, or barium sulfate; and
(c) the insulating layer comprises a polymer, wherein the polymer comprises at least one of a homopolymer of polyvinylidene fluoride, a copolymer of polyvinylidene fluoride, a copolymer of hexafluoropropylene, polystyrene, polyphenylacetylene, polyvinyl sodium, polyvinyl potassium, polymethyl methacrylate, polyethylene, polypropylene, or polytetrafluoroethylene.

16. An electronic apparatus, comprising an electrochemical apparatus, the electrochemical apparatus comprises an electrolyte,
wherein the electrolyte comprises a compound of formula I and lithium difluorophosphate, 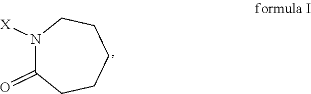
wherein X is selected from the group consisting of a substituted or unsubstituted C₁₋₁₀ alkyl group, a substituted or unsubstituted C₂₋₁₀ alkenyl group, a substituted or unsubstituted C₁₋₅ alkyl sulfonyl group, and a substituted or unsubstituted C₂₋₅ acyl group, and in the case of substitution, a substituent is selected from a cyano group and halogen.

17. The electronic apparatus according to claim 16, wherein the electrochemical apparatus further comprises a positive electrode, wherein the positive electrode comprises:
a positive electrode current collector;
a positive electrode active material layer; and
an insulating layer disposed on the positive electrode current collector and meeting at least one of condition (a), condition (b), or condition (c):
(a) a gap is provided between the insulating layer and the positive electrode active material layer, a width of the gap being less than or equal to 2 mm;
(b) the insulating layer comprises inorganic particles, wherein the inorganic particles comprise at least one of aluminum oxide, silicon dioxide, magnesium oxide, titanium oxide, hafnium oxide, tin oxide, ceria oxide, nickel oxide, zinc oxide, calcium oxide, zirconium dioxide, yttrium oxide, silicon carbide, boehmite, aluminum hydroxide, magnesium hydroxide, calcium hydroxide, or barium sulfate; and
(c) the insulating layer comprises a polymer, wherein the polymer comprises at least one of a homopolymer of polyvinylidene fluoride, a copolymer of polyvinylidene fluoride, a copolymer of hexafluoropropylene, polystyrene, polyphenylacetylene, polyvinyl sodium, polyvinyl potassium, polymethyl methacrylate, polyethylene, polypropylene, or polytetrafluoroethylene.
